(19) United States
(12) Patent Application Publication
(10) Pub. No.: US 2016/0300242 A1
(43) Pub. Date: Oct. 13, 2016

(54) DRIVER VERIFICATION SYSTEM FOR TRANSPORT SERVICES

(71) Applicant: UBER Technologies, Inc., San Francisco, CA (US)

(72) Inventors: Michael Truong, San Francisco, CA (US); Benjamin Kolin, Sunnyvale, CA (US); Rami Mawas, Dublin, CA (US)

(21) Appl. No.: 14/683,961

(22) Filed: Apr. 10, 2015

(51) Int. Cl. G06Q 30/00; G10L 17/00; G01S 19/13; G06K 9/00

(52) U.S. Cl. CPC G06Q 30/0185; G06K 9/00288; G10L 17/005; G01S 19/13

(57) ABSTRACT

A driver verification system and method is provided in which a driver profile is determined for a driver, and the driver profile is used as a basis of comparison with monitored actions of the driver during a shift. A preliminary verification determination can be made for the driver based at least in part on the comparison. From the comparison, a verification action can be required from the driver, and the verification action can be evaluated to determine whether the driver is true and authorized as to his or her identity.

### BACKGROUND

Transport services are increasingly becoming more diverse and common, particularly with the advance of on-demand services. Many such services enable individual users to participate in the role of driver. For example, transport services currently exist which enable users acting as drivers to provide transport for other users, as well as to deliver packages, goods and/or prepared foods. Still further, some transport services enable users to operate as drivers in connection with performing tasks or providing different types of location-dependent services.

### BRIEF DESCRIPTION OF THE DRAWINGS

FIG. 1 illustrates a driver verification system, according to one or more embodiments.

FIG. 2 illustrates a method for monitoring drivers of a transport service in order to prevent driver-substitution fraud.

FIG. 3 illustrates an example method for requesting verification of drivers based on a cumulative authentication determination.

FIG. 4A through FIG. 4F illustrate examples of driver interfaces for displaying verification communications, according to one or more embodiments.

FIG. 5 is a block diagram that illustrates a computer system upon which embodiments described herein may be implemented.

FIG. 6 is a block diagram that illustrates a mobile computing device upon which embodiments described herein may be implemented.

### DETAILED DESCRIPTION

Embodiments described herein include a driver verification system and service to authenticate drivers of a transport service so as to prevent driver-substitution fraud. In some embodiments, driver verification includes authenticating individual drivers as being the true and authorized individual, or alternatively, identifying drivers as unauthorized substitutes for authorized individuals. Examples recognize that with increasing number of drivers and transport services, a risk exists for a network service provider (e.g., an entity that operates a service arrangement system) when authorized drivers can lend their service identity to unauthorized individuals to enable the unauthorized individuals to impersonate the driver and otherwise have a role which they would not otherwise be able to have (e.g., unauthorized driver may have a poor driving record). Such unauthorized driver substitutions can raise issues of liability and safety, particular since non-authorized individuals may not have undergone screening (e.g., background or driving checks) or been approved for the role.

While it is desirable to verify that a given driver can be authenticated, service arrangement systems (e.g., transport systems) enable a vast number of vehicles and drivers to use such systems. The cost and resources needed to equip such vehicles with specialized hardware or communication interfaces for driver verification purposes can be prohibitively expensive. Thus, for example, while it may be possible for vehicles to carry retina or fingerprint scanners to verify drivers before they provide transport services, the cost of adding such equipment can be burdensome given the total number of vehicles and drivers that are currently using the network service to provide transport services. Moreover, such equipment can be easily circumvented. For example, if fingerprint or retina scanners are used to enable vehicle ignition, the authorized driver can simply start the vehicle for the unauthorized driver. Accordingly, examples described herein provide for driver verification to be performed using equipment that drivers typically carry with them-specifically, mobile computing devices such as cell phones, feature phones (e.g., APPLE IPHONE), tablets or wearable electronic devices. Among other benefits, examples as described herein utilize the described equipment for performing verification of drivers, and thus reduces the need for individual vehicles or drivers to carry any additional specialized hardware. Moreover, examples as described enable driver verification to be performed using computing operations that are executed as background processes of a mobile computing device of a driver, without disturbing the driver's natural tendency and behavior. Moreover, examples as described enable data collection and verification to be selectively focused on instances and situations where verification checks are most needed. This reduces the volume of data that is processed and analyzed, leading to a more efficient result where individuals whom are verified have a much greater probability of being unauthorized substitutions.

Examples described herein include a driver verification system comprising a memory and a processor. The processor can execute instruction which are stored in memory in order to obtain one or more authentication datums for the driver. During a first set of transport service shifts (e.g., when the driver first “logs in” for a shift), a driver profile is determined using data provided from a mobile computing device that is associated with the driver and carried in the vehicle when the transport services are provided. The driver profile can be associated with the one or more authentication datums, and can identify one or more characteristics of the driver when the driver is on one of the transport service shifts. During a second transport service shift, data obtained from the mobile computing device of the driver is used to monitor the driver for information that is probative of the one or more characteristics. A preliminary verification determination can be made for the driver based at least in part on a comparison of the driver information and the driver profile. A verification communication can be generated for the driver based at least in part on the verification determination. The verification communication may specify one or more verification actions that the driver is to perform in order for the driver to be authenticated for his or her identity.

Still further, in some embodiments, a driver verification system and method is provided in which a driver profile is determined for a driver, and the driver profile is used as a basis of comparison with monitored actions of the driver during a shift. A preliminary verification determination can be made for the driver based at least in part on the comparison. From the comparison, a verification action can be required from the driver, and the verification action can be evaluated to determine whether the driver is the true and authorized individual for the role.

According to some examples, a driver verification system can operate to evaluate a verification response from the driver. The response can result in a verification determination which can conclude whether the driver is an unauthorized substitute or the authorized individual.

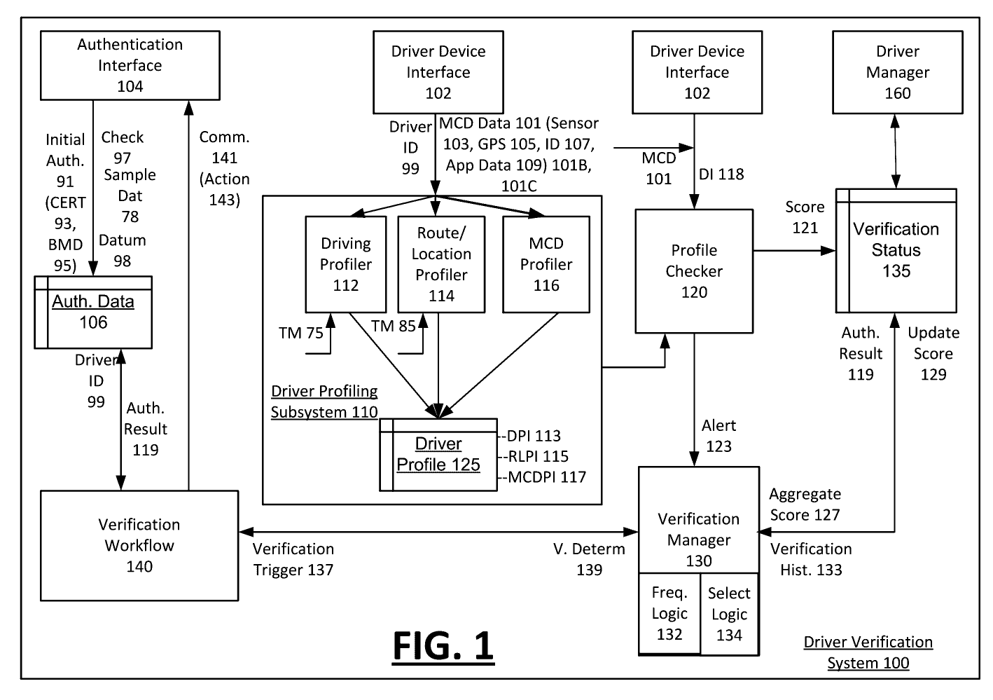

According to some examples, a system can be implemented in connection with the transport service for purpose of verifying that drivers in the field can be authenticated as to their respective identities. With the growth of on demand transport services, there are more drivers and more opportunities for individuals to impersonate authorized drivers, particularly when malfeasance on the part of authorized drivers facilitates unauthorized driver substitutions. While an authenticated driver of an on-demand system may have been checked for background and driving record, an unauthorized substitution can simply avoid being checked. In order to detect instances when a driver is actually an impersonator of another driver, verification checks (sometimes referred to as verification determinations) can be implemented on a driver verification system such as shown with an example of FIG. 1. As described with numerous examples, the verification checks may require the driver to perform verification actions which can either authenticate the driver to his or her identity, or expose the driver as an unauthorized driver substitution.

Among other benefits and technical effect, examples described herein promote secure operation of a network service which arranges transport or delivery services to be provided by drivers for requesting users, or alternatively, which provides transport services. The security of a transport system can be jeopardized when unknown individuals substitute for one another when tasks are performed. Additionally, dedicated or specialized devices (e.g., fingerprint scanner, retina scanner, etc.) for detecting impersonators can be expensive for the service provider and intrusive for the drivers of the service. Rather than utilizing specialized or new equipment, examples such as provided below utilize processes on existing devices operated by drivers (e.g., mobile computer devices) in order to determine when additional verification actions should be performed. Among other benefits, a computer system or service which provides the network services can operate more efficiently and securely by implementing examples such as provided below. The added level of security against unauthorized use can be achieved without use of additional hardware resources, and without significant disruption to the time requirements of the drivers who are being verified. Additionally, dedicated and specialized devices and hardware resources are more likely to both breakdown and malfunction. Malfunctioning devices can sometimes provide additional risk, in that the malfunction may be difficult to detect and generate results which are false matches.

Moreover, is some implementations, a transport arrangement system can be implemented to include a driver verification system, such as described with examples provided below. In such implementations, the transport arrangement system can operate to verify individual drivers during their respective shifts, and while those drivers operate in the field. In this way, the transport arrangement system can minimize the overall resource investment required to perform verification checks of their drivers.

As used herein, a client device, a driver device, and/or a computing device refer to devices corresponding to desktop computers, cellular devices or smartphones, personal digital assistants (PDAs), laptop computers, tablet devices, television (IP Television), etc., that can provide network connectivity and processing resources for communicating with the system over a network. A driver device can also correspond to custom hardware, in-vehicle devices, or on-board computers, etc. The client device and/or the driver device can also operate a designated application configured to communicate with the service arrangement system.

While some examples described herein relate to transport services, the service arrangement system can enable other on-demand location-based services (for example, a food truck service, a delivery service, an entertainment service) to be arranged between individuals and service providers. For example, a user can request an on-demand service, such as a delivery service (e.g., food delivery, messenger service, food truck service, or product shipping) or an entertainment service (e.g., mariachi band, string quartet) using the system, and the system can select a service provider, such as a driver, food provider, band, etc., to provide the on-demand service for the user.

One or more embodiments described herein provide that methods, techniques, and actions performed by a computing device are performed programmatically, or as a computer-implemented method. Programmatically, as used herein, means through the use of code or computer-executable instructions. These instructions can be stored in one or more memory resources of the computing device. A programmatically performed step may or may not be automatic.

One or more embodiments described herein can be implemented using programmatic modules, engines, or components. A programmatic module, engine, or component can include a program, a sub-routine, a portion of a program, or a software component or a hardware component capable of performing one or more stated tasks or functions. As used herein, a module or component can exist on a hardware component independently of other modules or components. Alternatively, a module or component can be a shared element or process of other modules, programs or machines.

Some embodiments described herein can generally require the use of computing devices, including processing and memory resources. For example, one or more embodiments described herein may be implemented, in whole or in part, on computing devices such as servers, desktop computers, cellular or smartphones, personal digital assistants (e.g., PDAs), laptop computers, printers, digital picture frames, network equipment (e.g., routers) and tablet devices. Memory, processing, and network resources may all be used in connection with the establishment, use, or performance of any embodiment described herein (including with the performance of any method or with the implementation of any system).

Furthermore, one or more embodiments described herein may be implemented through the use of instructions that are executable by one or more processors. These instructions may be carried on a computer-readable medium. Machines shown or described with figures below provide examples of processing resources and computer-readable mediums on which instructions for implementing embodiments of the invention can be carried and/or executed. In particular, the numerous machines shown with embodiments of the invention include processor(s) and various forms of memory for holding data and instructions. Examples of computer-readable mediums include permanent memory storage devices, such as hard drives on personal computers or servers. Other examples of computer storage mediums include portable storage units, such as CD or DVD units, flash memory (such as carried on smartphones, multifunctional devices or tablets), and magnetic memory. Computers, terminals, network enabled devices (e.g., mobile devices, such as cell phones) are all examples of machines and devices that utilize processors, memory, and instructions stored on computer-readable mediums. Additionally, embodiments may be implemented in the form of computer-programs, or a computer usable carrier medium capable of carrying such a program.

### System Description

FIG. 1 illustrates a driver verification system, according to one or more embodiments. In an example of FIG. 1, a driver verification system 100 is implemented with or as part of a transport arrangement service that provides or arranges transport services, such as people transportation, package delivery or on-demand delivery of mobile services. In an example of FIG. 1, the driver verification system 100 can be implemented as a network service which communicates with mobile computing devices (“MCD”) that are carried by drivers when drivers are available for providing transport services. The drivers of the transport arrangement system (e.g., those that use the system to provide transport services for requesting users) can correspond to users whom have the non-exclusive role of serving as a driver of a vehicle (e.g., their own vehicle).

In an example of FIG. 1, the driver verification system 100 includes a driver device interface 102, a driver authentication interface 104, a driver profiling subsystem 110, a profile checker 120, a verification manager 130 and one or more verification workflow processes 140. In some implementations, the driver verification system 100 can be implemented as a network service component which communicates with the mobile computing devices of drivers for one or more transport services. The driver verification system 100 obtains data from the mobile computing device data (“MCD data 101”) of a given driver when that driver is providing transport or available to provide transport (e.g., driver in vehicle or ready to accept a transport request). As described with various examples, the driver verification system 100 obtains the MCD data 101 for purpose of performing verification checks to authenticate drivers for their identity. Among other benefits, the driver verification system 100 enables repeated and managed verification checks on a large number of drivers, using sensor and/or other data obtained from the mobile computing device that are routinely carried by each driver. This enables data for driver verification to be obtained from the mobile computing device that is carried by each driver, rather than by specialized devices which add expense and inefficiency (e.g., Onboard Diagnostic interface devices, biometric sensors such as fingerprint or retina scanner, etc.). By way of example, the mobile computing device carried by individual drivers can correspond to a cellular telephone/message device (e.g., feature phone, smart phone), tablet or wearable computing device (e.g., computerized watch or eye glasses).

According to some examples, the driver profiling subsystem 110 operates to develop a driver profile, which can be represented by a multidimensional set of data, shown as a driver profile store 125 in FIG. 1. While a single driver profile store 125 is illustrated in FIG. 1, in examples described herein, a memory resource or database can store a plurality of driver profile stores 125 corresponding to a plurality of drivers. In some variations, the driver profiling subsystem 110 can be implemented during or as part of a training phase, where information is obtained about various aspects of an individual driver's session. Information obtained in the training phase can characterize a performance, effort or routine of the driver when the driver is providing transport, or alternatively when the driver makes himself available to a transport service (e.g., “on-duty”). Accordingly, the driver profile store 125 includes a set of parameters, of which individual parameters have values that are based on information which is obtained from a driver's work session. Furthermore, in some embodiments, the information that is determined from the driver's work session can be based primarily or exclusively on data communicated by a mobile computing device of the driver. In this way, the driver verification system 100 can perform verification checks on numerous drivers without expense of hardware or loss of convenience and time to the workforce.

In an example of FIG. 1, the driver verification system 100 can be utilized with a transport arrangement service that manages and/or coordinates numerous drivers. The profile checker 120 operates to determine driver information 118 about a driver providing a transport service, in order to compare the driver information 118 that is determined for an individual driver with characteristics that define aspects of the driver profile store 125. As described below, the driver information 118 can include MCD data 101 (or variants 1018, 101C). The characteristics used with the profile store 125 can be represented by parametric values. In different aspects, the comparison performed by the profile checker 120 can result in a determination of (i) whether verification of the driver is to be performed, (ii) a selection of a verification action that is to be performed by the driver, and/or (iii) a frequency or designation of time when one or more verification actions or checks is to be performed. In some variations, an output of the profile checker 120 can correspond to a confidence score 121. The confidence score 121 can represent a multisession assessment as to a likelihood that the driver is someone other than the person who is authenticated for that role. The profile checker 120 can generate the confidence score 121 to represent a confidence level for the driver verification system 100, based on a likelihood that the particular driver is genuine and not an imposter.

The verification manager 130 can process various types of information regarding the determination or confidence level of the a driver's verification status in order to trigger one or more verification actions to be performed by the user. As described with numerous examples, the verification actions can be selected by, for example, kind, severity, duration, frequency, or randomness, based at least in part on the confidence level determined by the profile checker 120 in the authenticity of the driver.

The verification workflow 140 operates to generate a verification communication 141 for the driver. The verification communication 141 can be communicated to the mobile computing device of the driver as, for example, an application notification or message (e.g., on a service application of the driver), by email, or text message. The verification communication 141 can specify a verification action 143, and the driver can respond to the communication by electing to perform the specified verification action 143. According to some examples, the driver can respond to the verification communication 141 by performing the specified verification action 143. The verification action 143 can be performed using, for example, resources of the driver's mobile computing device, or other computing platform. The authentication interface 104 can be implemented in part using a programmatic interface of the driver's mobile computing device. Accordingly, the authentication interface 104 can receive or capture data corresponding to the authentication action 143 of the driver. In some variations, the verification communication 141 can specify one or more verification actions 143 for the driver (whom can be identified using driver identifier 99) with parameters that confine or limit the response from the driver. For example, the communication 141 may specify that the driver has to perform the verification action 143 in a designated location (e.g., in a parking lot, at a particular address, etc.) and within a set parameter of time (e.g., within ten minutes, immediately, etc.).

In some examples, the verification action 143 can specify an action that enables the authentication interface 104 to obtain an authentication datum 98 from the driver device. The authentication interface 104 can implement the authentication check 97 by referencing the authentication datum 98 against the similar or like authentication datums that are stored with the authentication data store 106. The verification workflow 140 can then obtain the authentication result 119 for the particular driver. The authentication result 119 can be communicated as a verification determination 139, and the authentication result 119 can be used to either manage the driver (e.g., instruct the driver to stop driving), or update a score or other parameter of verification status store 135.

In more detail, during a set up phase, a driver may provide initial authentication information 91 to the authentication interface 104 in order to authenticate his or her identity. The initial authentication information 91 can correspond to, for example, a certified information 93 (e.g., driver's license, passport), which can be combined with an image or other relevant biometric data 95. To ensure the biometric data 95 is an authentication source, the biometric data 95 can be submitted by the driver concurrently or simultaneously with the certified information 93, via the authentication interface 104. As an addition or an alternative, the initial authentication information 91 can be provided by the driver as part of an on-boarding process. The various components of the user's authentication process (e.g., driver's license and biometric data captured when driver's license is submitted to authentication interface 104) can be stored in the authentication data store 106 for subsequent use. In some variations, the driver verification system 100 can extend or generate additional authentication sources for drivers, by collecting the biometric data 95 during the time period when the driver is holding a driver's license or passport or other identification mechanism. This allows for additional samples of biometric data 95 to serve as an authentication source. For example, when the driver is in possession of a driver's license, the driver's image can be captured (e.g., holding the driver's license), and further the driver can be required to perform certain actions to record different types of biometric data 95. As examples, the driver can be required to record fingerprint information, retina data, face image and/or voice data. In variations, some or all of the initial authentication information 91 can be obtained from the drivers when the driver first logs-in to work a first shift. The different types of biometric data 95 can be stored in authentication data store 106 and used as a basis for performing authentication of the driver at a later time. Additionally, the different types of biometric data 95 can enable multiple subsequent use of different kinds of authentication datums 98 for when a driver receives a verification communication 141. Examples recognize that by increasing the number and kind of authentication datum 98 which can be required from the driver, it is more difficult for unscrupulous authorized drivers to allow for impersonators.

At various times, a training phase can be implemented to determine the driver profile store 125. The training phase can be implemented as a background process, for example, just after the driver is initially authenticated, or after the occurrence of a milestone (e.g., one month or year since authentication documents were obtained from the driver) or events (e.g., after a driver is an accident, etc.). In variations, the training phase may be implemented continuously or semi-continuously over an extended duration (e.g., during a time when the driver works for a transport service). In such variations, information about the driver can be continuously obtained to update the driver profile store 125.

In an example of FIG. 1, the driver profiling subsystem 110 includes a driving profiler 112, a route/location profiler 114 and a MCD profiler 116 to determine and update the driver profile store 125. The driver profiling subsystem 110 can use MCD data 101 (which is communicated from the mobile computing device of the driver device) as a source for developing the driver profile store 125. For example, the mobile computing device can execute a process or application to communicate with the driver verification system 100. For example, the mobile computing device of each driver can include an application or process which executes to (i) initiate when the driver session begins, (ii) communicate MCD data 101 with the driver identifier 99 during the driver's work session, (iii) determine when the driver session is complete (e.g., the driver goes off-duty), and/or (iv) periodically communicate MCD data 101 when the application or process is operating on the mobile computing device. In some implementations, the MCD data 101 can provide an exclusive or primary source of data for developing/updating the driver profile store 125 for individual drivers. In particular, MCD data 101 can include various types of data which are acquired from the mobile computing device of the driver, such as sensor data 103, GPS data 105, MCD device identifier 107 and application data 109.

As an addition or alternative to MCD data 101, alternative input data 101B can be generated from resources which are embedded or otherwise integrated with the vehicle. For example, the input data 101B can be generated from an on-board diagnostic (“OBD”) interface residing with the vehicle, in which case the input data 101B can include various sensor information (e.g., velocity, RPM, brake sensor, etc.) which is maintained by the vehicle. As still another addition or alternative, the input data 101C can be received from an onboard sensor device, such as a device that includes accelerometers to obtain acceleration data (e.g., lateral and forward/backward) and/or geo-aware resources (e.g., GPS, magnetometer, etc.). For example, a signage or marker device can be affixed to the inside of the windshield. Examples of input data 101B, 101C can be communicated to components of system 100 using, for example, a mobile computing device of the driver. For example, the mobile computing device of the driver can communicate with the OBD interface or integrated marker device using Bluetooth or other wireless (or wired) communication medium in order to obtain the respective input data 101B, 101C.

In more detail, the driving profiler 112 can define parameters which characterize the driving style of the driver. The driver profiling subsystem 110 can obtain MCD data 101, which the driving profiler 112 converts to parametric values that quantitatively describe the driving style and/or behavior of the driver. The driving profiler 112 can be trained using a training model 75, which can, for example, provide and tune a model to select and/or weigh input data based on driver-specific tendencies. The driving profiler 112 can operate during a training phase in order to determine training data from the particular driver. By way of example, the driving profiler 112 can determine parametric values for individual drivers that are indicative of (i) a vehicle speed for the driver relative to, for example, a speed limit, (ii) a breaking characteristic or tendency of the driver, including typical breaking magnitude and/or duration, (iii) an acceleration characteristic or tendency of the driver, and/or (iv) a lateral acceleration or turning characteristic of the driver. As in addition or variation, the driving profiler 112 can detect distinguishing movements of the driver's mobile computing device during transport which are unique or particularly indicative of a specific driver. By way of example, the driving profiler 112 can record a propensity of the driver to change lanes quickly or break suddenly using a combination of sensor data 103 (e.g., from an accelerometer of the driver device). The driving profiler 112 can use aspects of the MCD data 101 to determine parametric values corresponding to the driving profile information 113. In particular, sensor data 103 and GPS data 105 can provide information that relates to lateral and forward/backward acceleration (e.g., from the accelerometer) and velocity (e.g., from the GPS and corresponding timestamps of the GPS location points) of the vehicle in which the corresponding mobile computing device is carried. In determining the driving profile information 113, other resources can also be utilized, such as a map resource (e.g., a map database accessible by the driver profiling subsystem 110) to determine speed limit, road type or road conditions.

In some variations, the driving profile information 113 can correspond to aggregate characterizations, which can, for example, categorize the overall driving style of the driver (e.g., “aggressive”, “calm”, “defensive,” etc.). Such characterizations can be based on, for example, thresholds or other logic which are established when analyzing the parametric values that comprise the driving profile information 113.

The route location profiler 114 can operate to obtain geometric or position-based parametric values from the MCD data 101, to enable the creation of route location profile information 115 (“RLPI 115”) for the driver profile store 125. By way of example, the RLPI 115 for a particular driver can identify one or more of: (i) a home position or location of the driver, (ii) routes or road segments typically taken by the driver, (iii) a geographic region where the driver typically operates in, (iv) location(s) where the driver launches the service application the driver device, provides input to go on-duty, provides input to go off-duty, and/or closes or suspends the service application, and/or (v) a type of road (e.g., highway versus back-roads) that the driver favors. In some variations, the route location profiler 114 can also include a training model 85 which develops a model to select and weigh input data for subsequent analysis.

As an additional or alternative, the driver profiling subsystem 110 can include the MCD profiler 116 to determine MCD profile information 117 for the driver profile store 125. The MCD profiler 116 can operate to determine identifying characteristics in a manner which the driver operates his or her mobile computing device, in order to determine the MCD profile information 117. For example, the MCD profiler 116 can detect or determine background processes used on the mobile computing device of the device before or during when transport is offered or provided. As an addition or alternative, the MCD profiler 116 can identify a device identifier (e.g., phone number, mobile device identification number) which is used by the mobile computing device of the driver, so that certain uses of the device can be detected (e.g., the driver making a phone call to a customer when providing transport). When the mobile computing device is detected in such uses, the location of the mobile computing device can be compared with that of the vehicle of the driver in order to determine whether the approximate location of the mobile computing device and vehicle are the same. In this way, a phone number or other similar identifier of the mobile computing device can serve as the MCD profile information.

When the driver profile store 125 is established for a particular drive, the driver verification system 100 can operate in an active phase for that driver. In the active phase, the profile checker 120 can receive the driver identifier 99 and MCD data 101 via the driver device interface 102. The profile checker 120 can access the driver profile store 125 of the driver in order to perform a comparison of the MCD data 101 against relevant aspects (e.g., DPI 113, RLPI 115, MCD profile information 117) of the driver profile store 125. The comparison can result in a determination that the MCD data 101, as collected over a given duration of time, is predicted or within a threshold of values predicted by the respective model(s) of the driver profile store 125. For example, the measured data can be compared to model data to determine a distance measure, which in turn can be compared to threshold values. As an addition or alternative, the determination made by the profile checker 120 is a score 121 which can provide a range of values that indicate a level of predictability of the MCD data 101 as compared against relevant aspects of the driver profile store 125. The score 121 can be stored in a verification status store 135, in association with the driver identifier 99, so that the value can be updated or otherwise weighted over the course of a duration in which the driver completes additional shifts. By way of example, the profile checker 120 can determine the score 121 to be within a range of values that are deemed “good”, “fair” or “bad.” The “good” or “fair” scores can be stored in the verification status store 135 along with a timestamp when the check was performed, while the “bad” score can result in the generation of alert 123, to trigger the verification manager 130 to initiate a process for verification of the driver. As an addition or an alternative, the “bad” score can also be stored in the verification status store 135 along with the timestamp. In some embodiments, the profile checker 120 can signal score 121 to update an aggregate score 127, which can be based on the score 121 of multiple sessions of the driver.

The verification manager 130 can determine when a verification action should be requested from the driver based on one or more criteria. In one implementation, the verification manager 130 makes the determination to request the verification action when the aggregate score 127 reaches a threshold value. For example, the profile checker 120 can record relatively low confidence scores 121 for multiple shifts (or measured durations within shifts), triggering the aggregate score 127 to reach a threshold that requires verification action. As in addition to variation, the verification manager 130 can make a determination to request verification action in response to criteria such as the passage of time (e.g., every month or year, a driver is requested to perform a verification action), the occurrence of an event (e.g., the driver is inactive for an extended duration or has a different vehicle), or random selection.

In some variations, the verification manager 130 includes logic for selecting one of multiple possible verification actions to request from the driver. In particular, the verification manager 130 can include a frequency logic 132 and a selection logic 134. The frequency logic 132 operates to determine the frequency for requesting verification actions from the driver, which can be based on factors such as the aggregate score 127, the history of the driver (e.g., length of time the driver has been using the transport arrangement system overall or the length of time the driver has been currently on-duty or has the service application running), or the duration from when the driver was last authenticated in person or through other mechanisms. The selection logic 134 operates to determine a verification action for the driver. In one implementation, a list of possible verification actions can be sorted by priority or level based on intrusiveness and/or effectiveness of the verification action authenticating the suspected driver. By way of example, the selection logic 134 can select the verification action from a list of possible verification actions, which can also be sorted by level: voice check (lightest), picture check (light), personal question and challenge (medium), call placement and GPS check (medium) (e.g., driver is asked to make a call using their phone when arriving at a particular location), video and GPS check (hard) (driver takes video clip with surrounding and GPS tag), and/or in-person authentication to a trusted authentication source. The selection logic 134 can select the verification action based on one or more of (i) the aggregate score 127, (ii) consideration of prior verification actions requested, such to avoid a repeat instances of the same verification action being asked, (iii) random selection, (iv) seniority or trust level of the driver, and/or (vi) random selection.

The verification manager 130 can communicate a verification trigger 137 to the verification workflow 140. The verification trigger 137 can specify the verification action that is requested of the driver, as well as other parameters or information which may be necessary to evaluate the driver's response to the verification action. For example, the verification trigger 137 can include elements of the MCD data 101, such as driver identification 99 and/or GPS data 105 (indicating current position) for use with authenticating the driver.

The verification workflow 140 can include rules or other logic for implementing one or more specified verification actions. In particular, the verification workflow 140 can generate (i) a verification communication 141 that specifies a verification action 143 that the driver needs to perform, and (ii) action specific processes or logic for making the verification determination once the user performs the action. Depending on implementation, the verification action that is requested from the driver can be simple or complex. The simple verification actions may only require the driver to perform one operation, such as take an image or generate a voice file. The more complex verification actions may require the driver to perform a series of operations, such as actions in which the driver makes a video clip by first panning to a landmark or street sign, and then showing himself in the assigned vehicle at the same location. In some variations, the verification work flow 140 can cause the generation of prompts, human instructions or other programmatically triggered guides to direct the driver to perform the stated verification action, and to submit a resulting sample datum 78 for subsequent verification. As an addition or variation, the verification work flow 140 can include additional programmatic resources for performing various kinds of analysis, including image or audio analysis. The programmatic resources of the verification work flow 140 can also access and use the additional programmatic resources in order to ensure completion of the tasks specified in the verification actions.

In an example of FIG. 1, the verification communication 141 and the verification action 143 can be communicated to the driver via the authentication interface 104. The driver can respond by performing the requested action, which can result in the driver providing a sample datum 78 for use in subsequent verification operations. The authentication interface 104 can store the sample datum 78, and programmatic resources of the verification workflow can perform necessary analysis on the sample datum 78 to make the verification determination. The authentication interface 104 and/or the verification workflow 140 can implement the programmatic resources for determining whether the sample datum 78 is a match, or alternatively, a sufficient match for a corresponding authentication datum 98. In performing the comparison, the verification workflow 140 can perform a variety of different types of analysis, including image analysis to compare images of the sample datum 78 to those of the authentication datum 98. For example, the verification workflow 140 can perform face recognition on the sample datum 78 to compare with the authentication datum 98 (e.g., picture of the driver holding his government issued identifier (e.g., driver's license or passport). As an addition or variation, the verification workflow 140 can also perform audio or voice analysis to compare the two datums. The result of the comparisons can be binary (match/no match) or on a scale (e.g., probability of match score). In the latter case, if the probability of match score exceeds a threshold, the verification determination can be made. In variations, however, the match score may also be stored and utilized to (i) trigger another verification check, (ii) weight or adjust the aggregate score 127 of the driver (e.g., increase or decrease the aggregate score), (iii) trigger the use of a different verification determinations, and/or (iv) adjust the timing of the next verification determination. In specifying the verification action(s) and evaluating the response, the verification workflow 140 can also utilize programmatic resources which analyze various forms of contextual data, such as geographic data (e.g., to place location of the driver at a given instance) or image analysis. By way of example, the verification workflow 140 can perform or utilize image analysis to view text in images (e.g., read street sign), recognize landmark and/or process maps or geographic information. In the latter case, for example, the driver can be instructed to perform the verification action at a particular location, and the verification workflow can verify that this action was performed.

The verification workflow 140 can process the authentication result 119 as a verification determination 139. In an example of FIG. 1, the verification determination 139 can be communicated to the verification manager 130, which can update the aggregate score 127 (“updated score updated score value 129”). In a variation, the verification manager 130 can store the underlying authentication result 119 for use as historical data. For example, if the driver has multiple instances when the verification determination 139 is borderline passing then one or more values that are based on the authentication result 119 can be stored and used in selecting a next verification action or a time when the another verification determination will be performed. For example, the authentication score 119 can be implemented as a score represents a confidence value in which verification can be “certain” (e.g., score is above a highest threshold), “borderline” (e.g., score is above acceptable-threshold and below highest threshold), “uncertain” (e.g., score is below acceptable threshold and above unacceptable threshold) or “not acceptable” (e.g., score is below unacceptable threshold). The verification manager 130 can weigh down or trigger performance of a verification action based on the presence of historical data, such as provided by storing the authentication result 119 for multiple driver sessions or authentication attempts of the driver.

The driver manager 160 can access the verification status store 135 for the particular driver in order to implement control or management function on the driver. For example, if verification determination 139 indicates that the driver may be an imposter, then the driver manager 160 can communicate a message or programmatic control to cause the driver to cease work until authentication can be shown. Likewise, if verification determination 139 indicates that the driver is the actual individual who should be providing the service, the driver manager 160 can remain inactive for the driver in that instance.

### Methodology

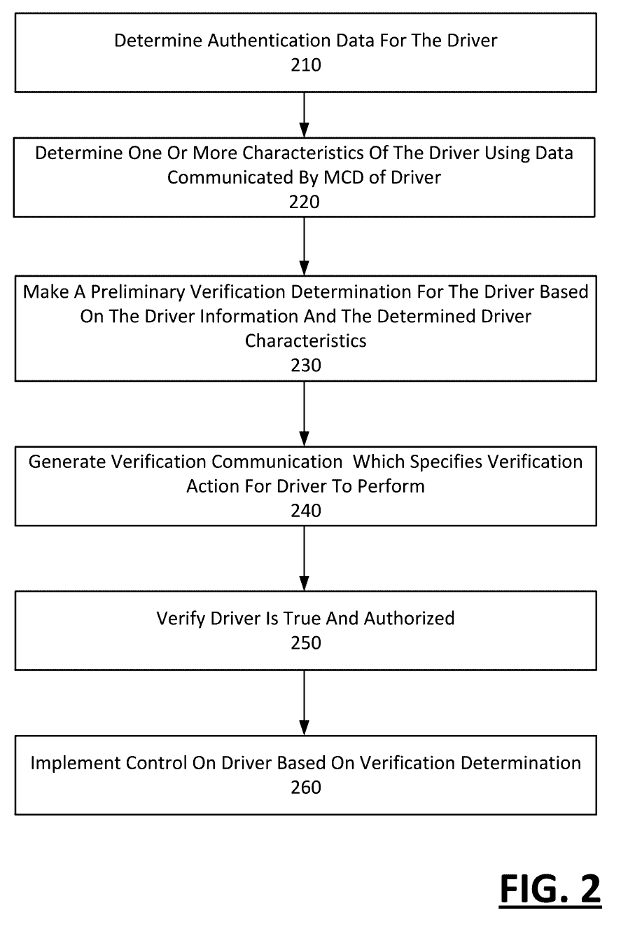

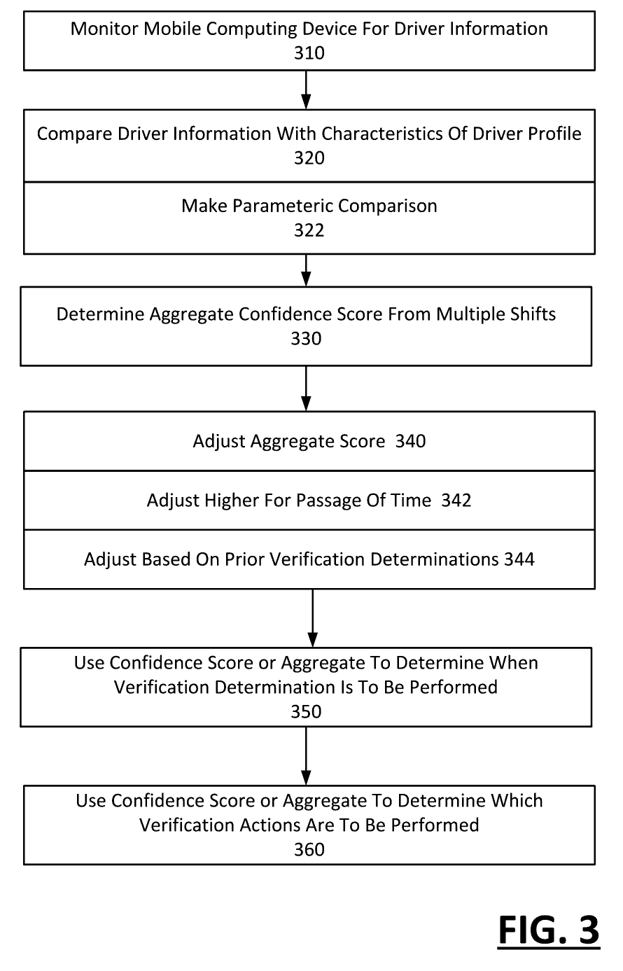

FIG. 2 illustrates a method for monitoring drivers of a transport service in order to prevent driver-substitution fraud. FIG. 3 illustrates an example method for requesting verification of drivers based on a cumulative authentication determination. In describing examples of FIG. 2 and FIG. 3, reference is made to examples of FIG. 1 for purpose of illustrating suitable components or elements for performing a step or sub-step being described.

With reference to FIG. 2, an authentication phase can be implemented at various times during a driver's relationship with a service (210). In one implementation, authentication can be performed at an initial time when the driver is first registered to operate shifts for a transport service. As an additional or alternative, authentication may be required from an existing driver periodically (e.g., every year) or in response to events or conditions (e.g., driver an activity for extended duration, accident etc.). The driver verification system 100 can include logic of programming such as provided with the authentication interface 104, to guide the user actions in the authentication phase. For example, the user may be required to capture an image of his or her driver's license, and the authentication interface 104 may require the driver to capture a picture of his while holding the license. The submission of the authentication seed can accompany the use's submission of face image, voice sample and/or other biometric data. The driver verification system 100 can record the additional submissions as authentication datums 98, which provide additional sources of authentication when verification actions are requested from the driver. By way of example, the authentication interface can request a driver to provide a voice utterance, video clip, biometric information (e.g., finger or retina scan) or other information for storage and subsequent use as an authentication datum 98. Thus, the authentication seed can be used to determine and record additional authentication datums 98 for the driver.

In addition to authentication, one or more distinctive characteristics of the driver can be determined using the mobile computing device (and/or other device) carried by the driver during a shift (220). According to some examples, a training phase can follow the authentication phase. The training phase can be implemented to determine distinctive characteristics of the driver's actions or behavior, using data communicated from the driver's mobile computing device, or other readily available network enabled communication interface (e.g., vehicle Internet connection). The driver profiling subsystem 110 can implement one or multiple processes to determine different types of characteristics from data communicated from a vehicle of the driver. In some variations, the driver verification system 100 can utilize data communicated from multiple devices within the driver vehicle, such as from an embedded network-enabled communication interface of the vehicle. The driver profiling subsystem 110 can use one or multiple training models in order to analyze and make meaningful use of the data communicated from the vehicles. For example, in one implementation of the driver verification system 100, driver information that is collected over multiple shifts can be aggregated and used to model driver characteristics of driver behavior and performance style. The driver profile store 125 can use parametric values to model and quantify characterizations that are learned from (i) the driving style of the driver, (ii) the route taken or locations of the driver, and/or (iii) other mobile computing device activities performed by the driver during a shift. Logic utilized by the driver profiling subsystem 110 (e.g., training models) can structure, weight and define quantitative parameters that characterize at least some aspects of the driver performance or behavior. The driver profile store 125 can include quantitative parameters or categorizations which are descriptive of the driver style and behavior over a duration of time which can include multiple shifts (e.g., week, month or year). By way of examples, the parameters of 125 can classify the driving style of a driver, quantify an average or median number of miles the driver travels during a transport session, or define a general geographic location where the driver is normally located. As further examples, the parameters of 125 can include: average or median number of hours worked in a work session, average or median number of transports provided in a work session, average or median fare collected (or size of typical transport job). For profiles directed to route or location, statistical analysis can be utilized to measure, for example, likely routes or locations of the driver, as well as typical location/route of the driver over the course of a shift. The training phase can be performed at an initial instance, such as following a set up phase which can occur when a new driver registers with the service. For example, the training phase can be established over the course of a driver's first few shifts, in order to determine parametric values that characterize driver behavior and performance style. In variations, the training phase can occur repeatedly, so as to fine-tune and/or develop dimensionality of driver behavior and performance style.

Once the profile of the driver is established, the driver verification system 100 can initiate verification checks in which a preliminary verification determination is made about the driver during a shift (230). The preliminary verification determination can be implemented using driver information obtained during the shift (or portion thereof). In one implementation, the preliminary verification determination can be implemented using a confidence score 121 that is determined from comparing (i) driver information obtained from the mobile computing device (or other device) of the driver and carried into vehicle during the driver shift, and (ii) information in a corresponding driver profile. In one embodiment, the driver information can correspond to MCD data 101, obtained during the driver's shift. Among other benefits, verification can be performed with relatively little cost or inconvenience to the driver, meaning verification can be performed repeatedly during a given drivers shift. In some implementations, verification determinations can be made multiple times over the course of the drivers shift. In most cases, the verification determinations do not result in the driver having to perform an action, but in a small portion of cases, the drivers may need to take action.

Based on the preliminary verification determination, the driver verification system 100 can specify one or more verification actions from the driver (240). With reference to an example of FIG. 1, when the preliminary verification determination results in the confidence score 121 dropping below a threshold, or alternatively, the aggregate score 127 dropping below a threshold, then system 100 triggers a requirement for further verification determinations from the driver. The components of the driver verification system 100 may generate verification communications 141 for the driver, and require the driver to perform one or more verification actions.

By way of example, the verification actions that may be required of the user can include image based verification, such as provided by the driver taking a self-picture of video. In some variations, the requirement for image based verification can include requirements that the driver pose or take the picture in a manner that reduces the ability of an impersonator to take a picture of another picture of the true driver. In other variations, the image based verification can include additional requirements of corroboration, such as requirements of the image to include geo-tag or a backdrop of a landmark or street. Alternatively, the verification actions 143 can require the user to provide a voice or audio input, such as by way of the driver submitting a voice recording or speaking into the microphone of the mobile computing device. Still further, the verification requirement can require the user to check-in to a site to be verified by a human. As variations, the verification actions 143 can require other forms of biometric data verification, such as fingerprint scan or retina scan. Still further, the verification actions can include challenging the user with knowledge that is likely known only to the driver.

The verification actions that are performed by the driver can then be evaluated to determine if the driver is the true and authorized individual or a driver substitution (e.g., imposter) (250). In some variations, the determination is probabilistic, and the verification determination can include a probability or confidence value.

The driver verification system 100 can implement one or more driver controls or follow-on actions based on the verification determination (260). For example, if the driver verification determination indicates the driver is an imposter, then the driver manager 160 can implement the control action of terminating or suspending the account of the driver. In variations, if the driver verification indicates a lack of confidence in the verification determination, then the driver manager 160 and/or verification manager 130 can perform a second verification determination (e.g., with higher safeguard), lower the aggregate score 127 and/or increase the frequency or occurrence of the next verification action.

With reference to FIG. 3, when the driver profile is established for a given driver, the mobile computing device of the driver can be monitored for one or more types of driver information (310). According to some embodiments, the driver information can include position data and sensor data. The position data can be determined from, for example, GPS resources of the driver's mobile computing device. The sensor data can include accelerometer data, such as acceleration data that is indicative of forward and backward acceleration, as well as lateral acceleration as measured by the driver's mobile computing device. The position and/or acceleration data can be cross-referenced to a map so that the acceleration data can be interpreted as braking data (e.g., when map indicates red light), velocity of the driver's vehicle, a geographic region of the driver's vehicle, turning data, routes taken by the vehicle, and/or other markers of the driver's style or behavior. The position and sensor data of the mobile computing device can be combined with other information, such as data which is descriptive of the manner in which a service application for the transport services is used.

The driver information can be compared to characteristics of the driver profile store for determining when or how often driver verification is to be determined (320). In some implementations, the driver characteristics can be parametric, so that the comparison of the driver information is quantitative and results in a confidence score for the driver (322). The confidence score 121 can reflect a comparison of driver information to driver parameters for a driver shift or portion thereof. Additionally, the confidence score 121 can be obtained repeatedly for the driver in a given shift and/or over multiple shifts, and the confidence scores from multiple instances or shifts can be combined into the aggregate score 127 (330). In some implementations, the aggregate score 127 can reflect a trust level for the driver.

The aggregate confidence score can be cumulatively combined new confidence scores and further adjusted upward or downward for a variety of reasons (340). In one implementation, the aggregate score 127 can tend higher (or more confident) with passage of time (342), to reflect an assumption that most drivers will be bad actors. For example, once a preliminary trust level is reached, an assumption can more readily be made that the driver will not attempt to falsely switch with another driver. For example, with passage of time (e.g., several shifts, or over months), a threshold for when driver verification is triggered can be raised to permit more deviation from the expected driver style and behavior. Additionally, when verification determinations are required from the driver and the driver passes, the result can be used to weight the aggregate score 127 (344). Likewise, if the verification determination reflects uncertainty about the driver, the aggregate score can be lowered or weighted down.

The determination of confidence score(s) can be utilized in selecting when verification actions are to be performed by the driver (350). In some embodiments, the aggregate score 127 is used as a basis for determining when the confidence score 121 of the driver requires a verification determination. Additionally, as the aggregate score 127 represents the accumulation of confidence scores 121, newly obtained confidence score 121 may require more significant divergence from prior scores in order to trigger verification. As an addition or alternative, the confidence score 121 for a given shift (or portion of shift) can be compared to a threshold in order to determine whether a verification determination is needed. Still further, one aspect of the driver information can be used as the basis for triggering the verification determination, regardless of aggregate confidence value 127 or threshold for confidence score 121. For example, the driver may start in a new city or suddenly drive at very unusual speeds, in which case the need for verification can be triggered regardless of the driver's confidence score.

Additionally, the determination of confidence score(s) can be utilized in selecting which verification actions are to be requested from a driver (360). In one example, the aggregate score 127 can be used as a metric for selecting the verification action, with relatively low scores (or those reflecting new drivers) requiring more austere verification actions (e.g., video capture) as compared to those requested from more trusted drivers (e.g., provide voice sample by answering personal challenge question). The verification actions can be assigned priority values or other logic in order to enable the selection of verification actions based on confidence scores 121.

### EXAMPLES

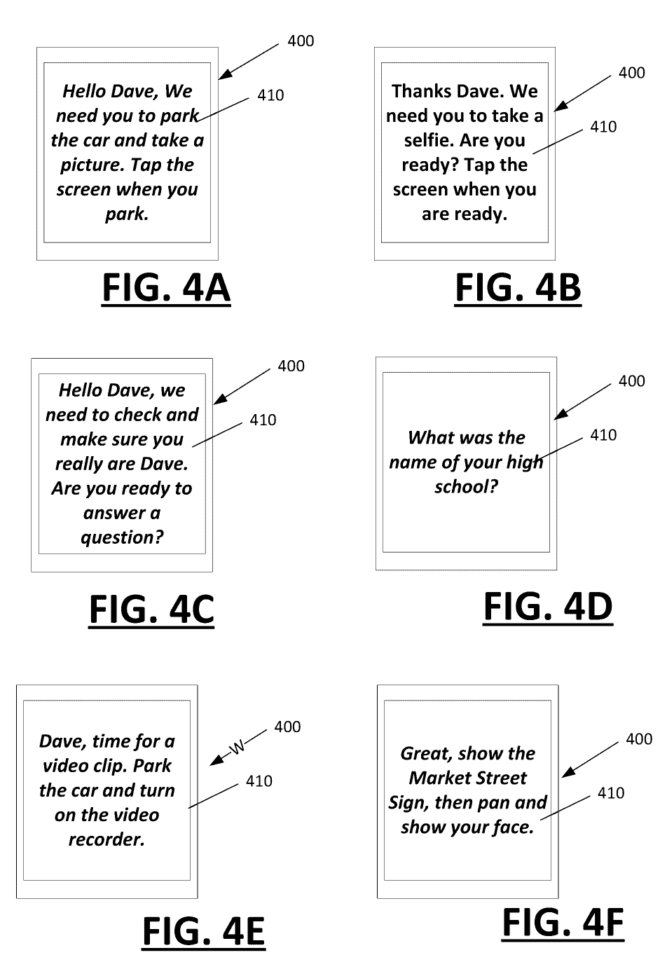

FIG. 4A through FIG. 4F illustrate examples of driver interfaces for displaying verification communications, according to one or more embodiments. For purpose of simplicity, selectable features and other graphics and content are omitted from the examples of FIGS. 4A through 4F. Examples of FIG. 4A through FIG. 4F are shown as being implemented on a mobile computing device 400 of a driver when the driver verification system 100 determines that verification actions are needed from the drivers. In FIG. 4A and FIG. 4B, a display screen 410 of mobile computing device 400 displays a verification communication in which the verification action needed is for the driver to take an image of himself. For example, the driver may be instructed to park and take the picture. By forcing the driver to take the picture immediately and/or at a designated location, the time and GPS information associated with the picture can be used to further authenticate the picture.

In FIG. 4C and FIG. 4D, a verification communication is shown which instructs the driver to provide a voice input. The voice input can be combined with a challenge question that asks the driver a challenge question (e.g., a question that is personal to the driver).

FIG. 4E and FIG. 4F illustrate a verification communication which prompts the user to provide a video input. The video clip can provide additional protection against fraudulent attempts, such as one in which a fake driver attempts to pass the verification determination by taking a picture of a picture of the real driver. In FIG. 4F, an alternative verification action required from the driver can require corroboration information, such as information indicating the driver is at a particular address or landmarks. As described with other examples, the verification actions may be prioritized or associated with other logic, so that more intrusive or difficult verification actions are generally required when confidence scores from driver monitoring are relatively low. In some examples, additional features, such as a timer (e.g., showing a count-down in seconds) can be included as part of the user interfaces, to provide the driver with an amount of time to complete the required action.

### Hardware Diagrams

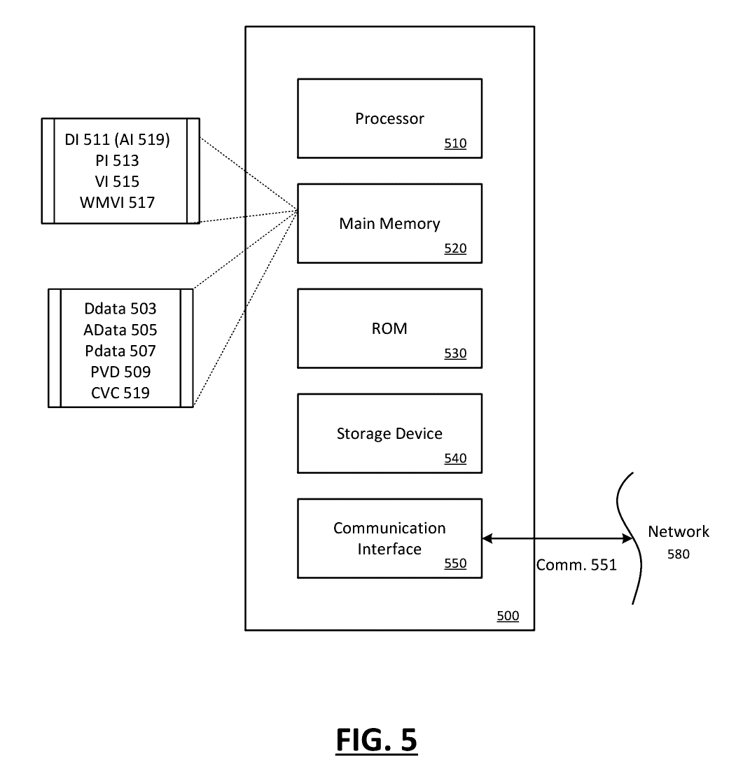

FIG. 5 is a block diagram that illustrates a computer system upon which embodiments described herein may be implemented. A computer system 500 can be implemented on, for example, a server or combination of servers. For example, the computer system 500 may be implemented as part of a network service for providing transport services. In the context of FIG. 1, driver verification system 100 may be implemented using a computer system such as described by FIG. 5. The driver verification system 100 may also be implemented using a combination of multiple computer systems as described by FIG. 5.

In one implementation, the computer system 500 includes processing resources 510, a main memory 520, a read-only memory (ROM) 530, a storage device 540, and a communication interface 550. The computer system 500 includes at least one processor 510 for processing information stored in the main memory 520, such as provided by a random access memory (RAM) or other dynamic storage device, for storing information and instructions which are executable by the processor 510. The main memory 520 also may be used for storing temporary variables or other intermediate information during execution of instructions to be executed by the processor 510. The computer system 500 may also include the ROM 530 or other static storage device for storing static information and instructions for the processor 510. A storage device 540, such as a magnetic disk or optical disk, is provided for storing information and instructions.

The communication interface 550 enables the computer system 500 to communicate with one or more networks 580 (e.g., cellular network) through use of the network link (wireless or a wire). Using the network link, the computer system 500 can communicate with one or more computing devices, and one or more servers. In accordance with examples, the computer system 500 receives driver information 511 from the mobile computing device of individual drivers. The executable instructions stored in the memory 530 can include authentication instructions 519, which the processor executes to generate interfaces for collecting authentication data (e.g., authentication data 98 of FIG. 1). The executable instructions stored in the memory 530 can also include profiling instructions 513 which implement models for modeling or otherwise characterizing different aspects of driver behavior. The executable instructions stored in the memory 530 can also include verification instructions 515 to receive driver information from a given shift and to compare the driver information with the profiles that are associated with the same driver. The comparison can result in the processor making a preliminary verification determination. The memory can further store verification workflow and management instructions 517 to perform verification checks on drivers, depending on the preliminary verification determination from execution of the verification instructions 515. The memory 530 can include data that associates or links for each of multiple drivers (i) a driver identifier 503 (e.g., by mobile computing device), (ii) authentication data 505, (iii) profile data 507, (iv) preliminary verification determinations 509 and (iv) completed verification checks 519. By way of example, the instructions and data stored in the memory 530 can be executed by the processor 510 to implement the driver verification system 100 of an example of FIG. 1. In performing the operations, the processor 510 can generate and send verification communications 551 via the communication interface 550 to the mobile computing device 600 of the driver.

The processor 510 is configured with software and/or other logic (shown with instructions 511-517 and data 503-519) to perform one or more processes, steps and other functions described with implementations, such as described by FIGS. 1 through 4, and elsewhere in the application.

Examples described herein are related to the use of the computer system 500 for implementing the techniques described herein. According to one embodiment, those techniques are performed by the computer system 500 in response to the processor 510 executing one or more sequences of one or more instructions contained in the main memory 520. Such instructions may be read into the main memory 520 from another machine-readable medium, such as the storage device 540. Execution of the sequences of instructions contained in the main memory 520 causes the processor 510 to perform the process steps described herein. In alternative implementations, hard-wired circuitry may be used in place of or in combination with software instructions to implement examples described herein. Thus, the examples described are not limited to any specific combination of hardware circuitry and software.

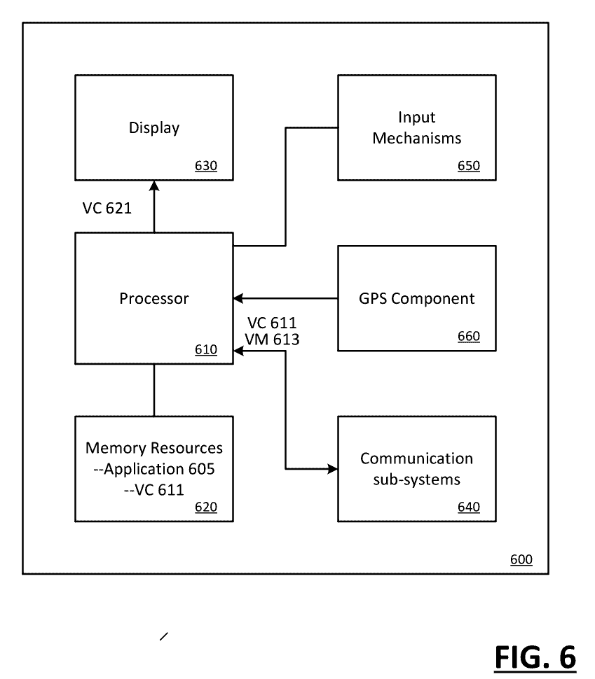

FIG. 6 is a block diagram that illustrates a mobile computing device upon which embodiments described herein may be implemented. In one embodiment, a mobile computing device 600 may correspond to, for example, a cellular communication device (e.g., feature phone, smartphone etc.) that is capable of telephony, messaging, and/or data services. In variations, the mobile computing device 600 can correspond to, for example, a tablet or wearable computing device. Still further, the mobile computing device 600 can be distributed amongst multiple portable devices of a driver.

In an example of FIG. 6, the computing device 600 includes a processor 610, memory resources 620, a display device 630 (e.g., such as a touch-sensitive display device), one or more communication sub-systems 640 (including wireless communication sub-systems), input mechanisms 650 (e.g., an input mechanism can include or be part of the touch-sensitive display device), and one or more location detection mechanisms (e.g., GPS component) 660. In one example, at least one of the communication sub-systems 640 sends and receives cellular data over data channels and voice channels.

A driver can operate the mobile computing device 600 when on a shift to provide, for example, transport services. The memory resources 620 can store one or more applications for linking the mobile computing device 600 with a network service that enables or otherwise facilitates transport services provided through the driver. The mobile computing device 600 can receive verification communication instructions 611 and messages 613 from a network service via one of the communication subsystems 640 (e.g., cellular interface). In response to receiving the verification communication instruction 611, instructions associated with the local application 605 can be executed in order to generate one or more communications that specify the verification action to users to perform. One or more parameters can also be specified with the verification action, such as parameters that (i) specify additional or augmented criteria for the action of the users to perform, (ii) specify a location of where the actions are to be formed, and/or (iii) timing parameters regarding when the action is to be performed. The processor 610 can display a verification communication interface 621 (such as described with examples of FIG. 4A through FIG. 4F) on the display device 630, or through other output interfaces (e.g., speaker).

While examples of FIG. 5 and FIG. 6 provide for a computer system 500 and mobile computing device 600 for implementing aspects described, in some variations, the mobile computing device 600 can operate to implement some or all of the functionality described with the driver verification system 100. For example, the application 605 can run various aspects of driver profile determination and require verification checks of the driver. The application 605 can include safeguards to enable verification and authentication to occur securely, with reduced or minimal use of external resources.

It is contemplated for embodiments described herein to extend to individual elements and concepts described herein, independently of other concepts, ideas or system, as well as for embodiments to include combinations of elements recited anywhere in this application. Although embodiments are described in detail herein with reference to the accompanying drawings, it is to be understood that the invention is not limited to those precise embodiments. As such, many modifications and variations will be apparent to practitioners skilled in this art. Accordingly, it is intended that the scope of the invention be defined by the following claims and their equivalents. Furthermore, it is contemplated that a particular feature described either individually or as part of an embodiment can be combined with other individually described features, or parts of other embodiments, even if the other features and embodiments make no mentioned of the particular feature. Thus, the absence of describing combinations should not preclude the inventor from claiming rights to such combinations.

What is being claimed is:

1. A driver verification system comprising:
a memory to store a verification instruction set;
a processor to use the verification instruction set to:
obtain one or more authentication datums for the driver, the one or more authentication datums providing an identity of the driver; during a first set of one or more transport service shifts, determine a driver profile using data provided from a mobile computing device that is associated with the driver, the driver profile being associated with the one or more authentication datum and identifying one or more characteristics of the driver when the driver is on one of transport service shifts;
during a second transport service shift,
(i) monitor, using data obtained from the mobile computing device of the driver, for driver information that is probative of the one or more characteristics;
(ii) make a preliminary verification determination for the driver based at least in part on a comparison of the driver information and the driver profile; and
generate a verification communication for the driver based at least in part on the verification determination, the verification communication specifying one or more verification actions that the driver is to perform to authenticate the driver as to identity.

2. The system of claim 1, wherein the one or more processors use the verification instructions to evaluate a verification response from the driver to authenticate the driver.

3. The system of claim 2, wherein the one or more processors use the verification instructions to control access by the driver to an associated transportation service when evaluating the verification response results in a determination that the driver is a substitute.

4. The system of claim 1, wherein the verification communication specifies a verification action that requires the driver to perform one or more of (i) take a self-picture or video while in a vehicle of operation, (ii) provide a voice sample, or (iii) answer one or more challenge questions.

5. The system of claim 4, wherein the one or more processors use the verification instructions to:
evaluate a verification response from the driver, when evaluating the verification response includes performing one or more of (i) a face recognition on the self-picture of video, or (ii) a voice recognition on the voice sample.

6. The system of claim 5, wherein the verification communication specifies one or more conditions for performance of the verification action, and wherein the one or more processors evaluate the verification response by confirming to one or more conditions have been met.

7. The system of claim 6, wherein the one or more conditions include a geographical location or timing parameter for when the verification action is to be performed, and wherein the one or more processors confirm that the verification action was performed at the geographical location or within a constraint of the timing parameter.

8. The system of claim 1, wherein the one or more processors obtain the one or more authentication datums by (i) obtaining an authentication seed for the driver, and (ii) instructing the driver to perform one or more actions to provide at least one additional authentication datum while the driver is authenticated with the authentication seed.

9. The system of claim 8, wherein the authentication seed includes a government issued identification, and the at least one additional authentication datum includes an image of the driver captured with the government issued identification.

10. The system of claim 9, wherein the at least one additional authentication datum includes a voice sample of the driver recorded when the image of the driver is captured.

11. The system of claim 1, wherein the one or more processors determine the one or more characteristics of the driver profile to include a set of parameters that quantitatively define a driving style of the driver.

12. The system of claim 11, wherein the one or more processors determine the driver information based on sensor information from at least one of an accelerometer or Global Positioning System (GPS) resource of the mobile computing device of the driver.

13. The system of claim 1, wherein the one or more processors determine the driver information to include one or more of (i) a set of locations where the driver is located during the second transport service shift, or (ii) a route driven by the driver during the second transport service shift.

14. The system of claim 1, wherein the one or more processors make the preliminary verification determination by determining one or more confidence scores which reflect a likelihood that the driver can be authenticated during one or more transport service shifts.

15. The system of claim 14, wherein the one or more processors specify the verification communication at an instance of time that is based at least in part on the one or more confidence scores.

16. The system of claim 15, wherein the one or more processors select the verification action that is to be performed by the driver based on the one or more confidence scores.

17. The system of claim 16, wherein the one or more processors store the one or more confidence scores and revise and update the one or more confidence scores by detecting driver information in each of a subsequent transport service shift.

18. The system of claim 1, wherein the one or more verification actions include one or more of (i) capturing an image of the driver, (ii) capturing a voice file of the driver, and/or (iii) recording a fingerprint or other biometric data of the driver.

19. The system of claim 1, wherein the one or more processors detect the one or more characteristics of the driver to include a communication identifier that is to be used by the driver during the shift, and wherein the one or more processors detect the driver information by comparing a location of use of the mobile computing device by the driver during the second transport service shift with a location that is known for the mobile computing device of the driver.

20. A method for performing driver verification, the method being implemented by one or more processors and comprising:
obtaining one or more authentication datums for the driver;
during a first set of one or more shifts in which the driver provides transport services, determining a driver profile using data provided from a mobile computing device that is associated with the driver, the driver profile being associated with the authentication datum and identifying one or more characteristics of the driver when the driver is on a shift;
during a shift of the driver in which the driver provides transport services,
(i) monitoring, using data obtained from the mobile computing device of the driver, for driver information that is probative of the one or more characteristics;
(ii) making a preliminary verification determination for the driver based at least in part on a comparison of the driver information and the driver profile; and
generating a verification communication for the driver based at least in part on the verification determination, the verification communication specifying one or more verification actions that the driver is to perform to verify the driver as to identity.

21. A non-transitory computer-readable medium that stores instructions, which when executed by one or more processors of a computer system, cause the computer system to perform operations that include:
obtaining one or more authentication datums for a driver;
during a first set of one or more shifts in which the driver provides transport services, determining a driver profile using data provided from a mobile computing device that is associated with the driver, the driver profile being associated with the authentication datum and identifying one or more characteristics of the driver when the driver is on a shift;
during a shift of the driver in which the driver provides transport services,
(i) monitoring, using data obtained from the mobile computing device of the driver, for driver information that is probative of the one or more characteristics;
(ii) making a preliminary verification determination for the driver based at least in part on a comparison of the driver information and the driver profile; and
generating a verification communication for the driver based at least in part on the verification determination, the verification communication specifying one or more verification actions that the driver is to perform to verify the driver as to identity.
